(19) United States
(12) Patent Application Publication
(10) Pub. No.: US 2003/0212602 A1
(43) Pub. Date: Nov. 13, 2003

(54) Order and inventory management system

(76) Inventor: Kurt Schaller, Valrico, FL (US)

Correspondence Address: Arthur W. Fisher, III, Suite 316, 5553 West Waters Avenue, Tampa, FL, 33634, US

(21) Appl. No.: 10/145,236

(22) Filed: May 13, 2002

(51) Int. Cl. G06F 17/60

(52) U.S. Cl. 705/22; 705/28

(57) ABSTRACT

An interactive business to business order and inventory management system to fulfill customer requisitions and provide current product inventory status information comprising a supplier computer having information processing and storage capabilities to establish inventory of products and designated shipping sites, to establish and maintain product inventory counts, receive, accept, fulfill, ship and bill individual customer product requests, to track status of customer product requests and to generate customer product order reports and at least one customer computer having information processing and storage capabilities to order products for shipment to designated sites and to selectively request customer product order reports operatively coupled by a data communications link capable of transferring data and information therebetween.

### BACKGROUND OF THE INVENTION

1. Field of the Invention

An order and inventory management system to fulfill customer requisitions and provide current product inventory information.

2. Description of the Prior Art

Numerous requisition and inventory management systems to manage and process purchase orders along with tracking inventory are known in the art.

With the introduction of automated real time inventory processing, many existing systems are not capable efficiently meeting the inventory and ordering requirements of either suppliers or customers. Thus, a need remains for a cost effective, real time order and inventory management system accessible to a wide range of discrete customers.

U.S. Pat. No. 5,712,989 teaches a requisition and inventory management system comprising a host computer and a local computer linked to permit two-way data communications in a real time environment. By accessing respective databases, each computer can build and transmit blocks of data relating to a particular requisition of an item in Just-in-Time (JIT) inventory or to the management of the JIT inventory. The other computer can then use the received data to continue processing of the requisition or to update JIT inventory records. Thus requisition records are created from a real-time interaction between the host and local computers with each computer using data from the respective database in conjunction with information entered by a Customer Service Representative (CSR) operating the local computer. The system of the present invention also utilizes means for automatically determining which items in the JIT inventory are likely to require replenishment. The system then proposes a purchase or transfer order for an optimum quantity of the item, which the CSR may accept or modify.

U.S. Pat. No. 5,727,164 shows an apparatus and method for managing the availability of items using a computer system to access databases located at offsite computers to retrieve/transmit preselected information pertaining to the availability of items from/to each accessed database. Categories of items are selected by a user prior to communicating with offsite computers so that only the categories of interest are selected and only data pertaining to those categories is downloaded to the requesting computer or uploaded from a called computer. Once data has been retrieved by the requesting computer, the user can use various parameters to select and display the received information in the selected categories. In addition, the requesting computer can automatically retrieve information from offsite computers at a predetermined time each day of the week.

U.S. Pat. No. 5,742,931 relates to a computerized system capable of receiving an input request from the orderer for a retailer, of searching selected wholesalers based on information obtained automatically from the wholesalers and of comparing these wholesalers to one another so as to provide a desired allocation of resources among these selected wholesalers such that orders are created for distinct items. The search may be performed, for example, on the basis of net price per unit item or on the basis of net price per unit weight or per unit volume. The system preferably automatically creates an order file which can be transmitted to the selected warehouses to order the selected products but which can be manually edited prior to transmission.

U.S. Pat. No. 6,029,140 discloses a computer system for establishing and reporting product delivery dates comprising the maintaining a customer preferences database having delivery and reporting preferences for individual customers including early and late delivery limits, performance measurement species, and desired advance delivery times. The system further includes a step of creating a customer order entry for a particular customer including a customer-requested delivery date supplied by the customer. A customer-preferred ship date is calculated for the customer order entry based at least in part upon the customer-requested delivery date and at least in part upon the particular customer's specified desired advance delivery time. The customer order entry is then routed to an order scheduler. The computer system displays the order scheduler the calculated customer-preferred ship date and obtains a targeted ship date for the customer order entry from the order scheduler. The system then calculates a targeted ship date window based upon the targeted ship date and the particular customer's preferred early and late delivery limits. On-time product delivery statistics are generated for individual customers in accordance with the individual customers' specified preferred performance measurement species.

U.S. Pat. No. 6,081,789 discloses a method for exchanging information between providers and users of products and services comprising an information management system comprising information processing and storage capabilities with electronic communication links that permit buyers and sellers to electronically connect with the information management system for information exchange. Limited electronic access to the information management system is provided to approved sellers of products and services. After approval, each such seller is able to access inventory information of that seller for amendment purposes. Similarly, limited electronic access to the information management system is provided to approved buyers of products and services and are provided a searching capability to search a compilation of a plurality of seller's inventory information using criteria specified by that approved buyer. In addition a buyer's listing of products and services is compiled from the compilation of the seller's inventory information for that buyer based on that buyer's search criteria.

U.S. Pat. No. 6,205,365 teaches a production management method for ordering parts and managing receipt and stock of the parts by use of a computer comprising inputting dates on which events related to delivery of the ordered parts take place during a period from the forwarding of the parts by the supplier to the receipt of the parts, as a plurality of delivery event dates and inputting a base date for management by designating one of the inputted delivery event dates. On the basis of the base date for management, management related to the receipt and stock of the parts is conducted.

### SUMMARY OF THE INVENTION

The present invention relates to a business to business order and inventory management system to fulfill customer requisitions and provide current product inventory information.

The system features an interactive inventory control method allowing individual customers to place on-line orders with a manufacturer or suppliers, check specific order status, verify shipping dates, billing information and other pertinent data.

Further, the system is capable of generating job estimates on-line, allow acceptance of estimates by return e-mail, automatically generate a job number and notify customer of job number by e-mail for customer's on-line job tracking.

The system may include such features or capabilities as a visual display of information related to previous orders such as date ordered, date completed, quantity ordered, job costs, ship-to address, i.e. customer, warehouse, drop shipped, or direct mail as well as the ability to generate reorders for individual or specific goods or products with provision for reorders with changes; replenish inventory levels on-line; generate daily inventory reports; automatic inventory reorder at predetermined level with customer notification; order approval by designated authorizing person or office and automatic shipping notification with tracking numbers upon shipment.

The invention accordingly comprises the features of construction, combination of elements, and arrangement of parts that will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a schematic of the order and inventory management system of the present invention in a network environment.

FIG. 1A depicts a computer used to implement the order and inventory management system of the present invention in a network environment.

FIG. 2 depicts the user menu of the order and inventory management system of the present invention.

FIG. 3 depicts the administrator menu of the order and inventory management system of the present invention.

FIGS. 4 and 5 are flow charts of the user access level of the order and inventory management system of the present invention.

FIGS. 6 through 15 are flow charts of the additional functions associated with the administrator access level of the order and inventory management system of the present invention.

FIGS. 16 through 24 depict various screen displays of the order and inventory management system of the present invention associated with selected functions.

Similar reference characters refer to similar parts throughout the several views of the drawings.

### DETAILED DESCRIPTION OF THE PREFERRED EMBODIMENT

The present invention relates to an interactive business order and inventory management system to fulfill customer requisitions and provide current on-line product inventory status information.

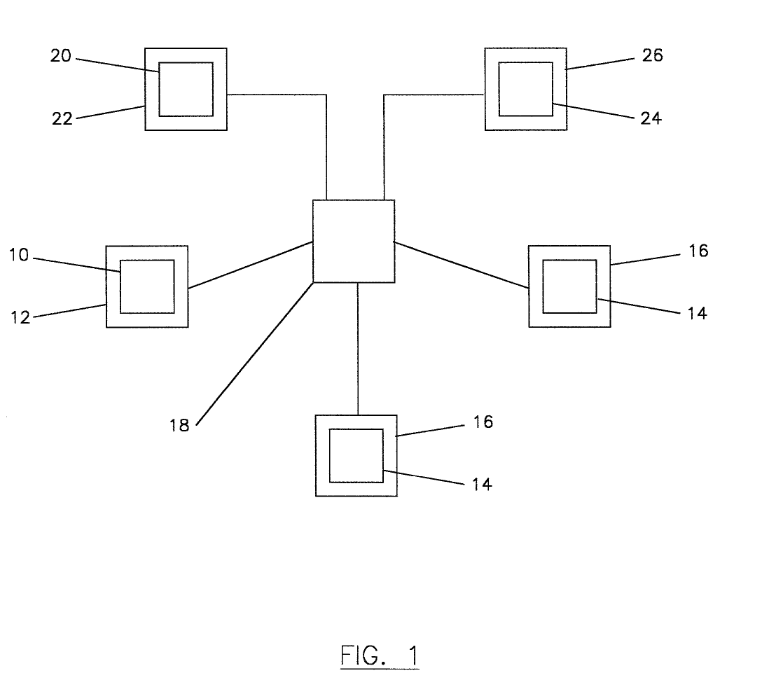

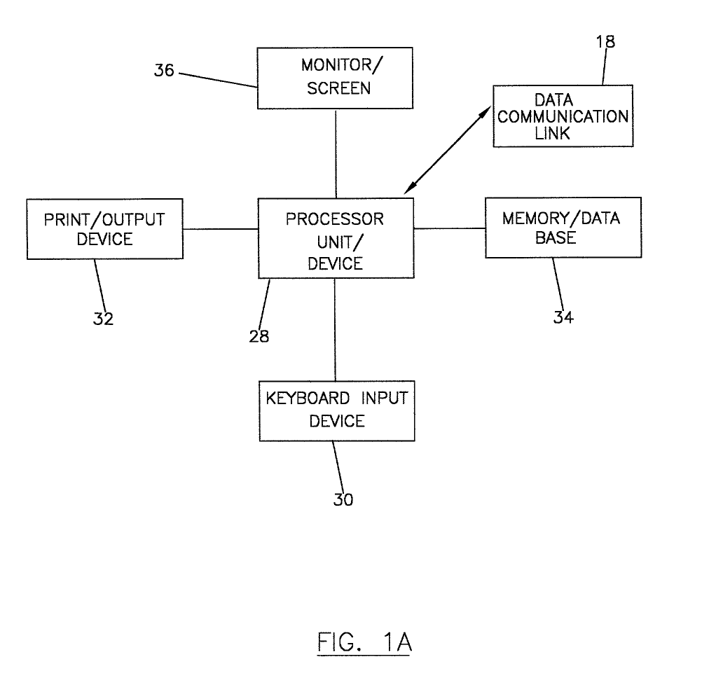

As shown in FIG. 1, the order and inventory management system of the present invention comprises a supplier computer 10 located at a supplier site 12 and a customer computer 14 located at one or more corresponding customer sites each indicated as 16 operatively coupled or linked by a data communications link 18 capable of transferring data and information therebetween. In addition, the supplier computer 10 is operatively linked to a warehouse/distribution center or facility computer 20 located at one or more corresponding warehouse/distribution centers or facilities 22 and a transportation/shipper facility computer 24 located at one or more corresponding transportation/shipper facilities 26 by the data communications link 18. The supplier computer 10 and the customer computer 14 may be operatively coupled to the transportation/shipper computer 24 by the data communications link 18. The warehouse/distribution center or facility 22 may be located at the supplier site 12.

The supplier computer 10 includes information processing and storage capabilities or means to establish and maintain an inventory of products and predesignated ship to sites, to establish and maintain product inventory counts, receive, accept, fulfill, ship and bill individual customer product requests, to track status of customer product requests and generate customer product order reports.

The customer computer 14 includes information processing and storage capabilities or means to order products for shipment to selected sites or predesignated ship to sites and to selectively request customer product order reports operatively coupled by the data communications link 18. The customer computer 14 may also be capable of creating and maintaining per-designated ship to sites.

As depicted in FIG. 1A, each computer 10, 14, 20 and 24 comprises a processor unit or device 28 operatively coupled to a keyboard or input device 30, a printer or output device 32, a memory or data base 34 and a monitor or screen 36. As previously described, the computers 10, 14, 20 and 24 are operatively coupled through the data communications link 18. The data communications link 18 may comprise any suitable state of the art transmitting/receiving system or means.

As discussed more fully hereinafter, the order and inventory management system is capable of placing on-line orders, replenishing customer inventory levels, generating and communicating inventory reports to individual users or customers, flagging inventory levels to reorder product inventory reaching a predetermined minimum level and informing the customers, generating shipping instructions to predesignated ship to locations and branch offices or selected ship to locations or branch offices when placing orders, approving orders or predetermined products and/or prices by a designated customer administrator, allow selective manager approval prior to transmission of orders to the supplier for shipment from inventory, real time inventory level reporting and shipping information such as tracking numbers automatically sent to customers upon completion of shipment from the warehouse/distribution center or facility 22. In addition, the tracking information may be directly linked between the customer site 16 and the transportation/shipping facility 26 for ease of tracking and data retrieval.

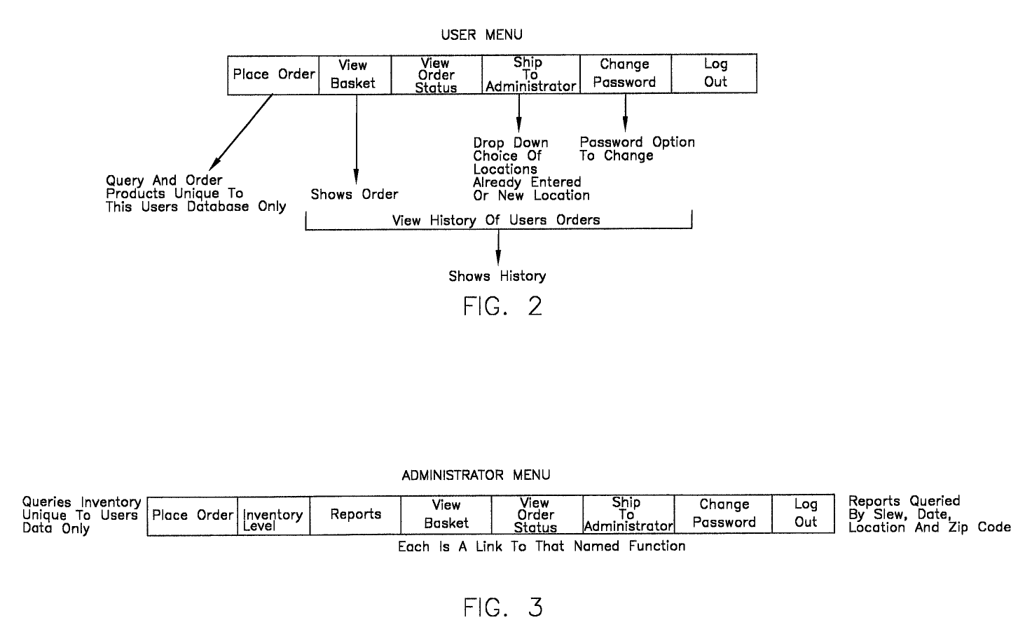

The order and inventory management system of the present invention comprises a multi-level access capability including an operator or customer order data and control access level and an administrator management data and control access level for different access levels to system data and control as reflected in the menus shown in FIGS. 2 and 3 3 respectively.

As described more fully hereinafter, once logged in or on line with the particular customer's information at the supplier site 12 on the supplier computer 10, the operator or customer is able to query or to select the placing of an order using the following steps: place order, view basket, view order status, ship to administrator, change password, log out.

In addition, the customer administrator can: place order, inventory level, generate reports, view basket, view order status, ship to administrator, change password and log out.

The supplier has full or global access to all data and information of each memory or data base 34 for each customer site 16, each warehouse/distribution center or facility 22 and each transportation/shipper facility 26. The supplier is also able to generate all reports that customers can generate.

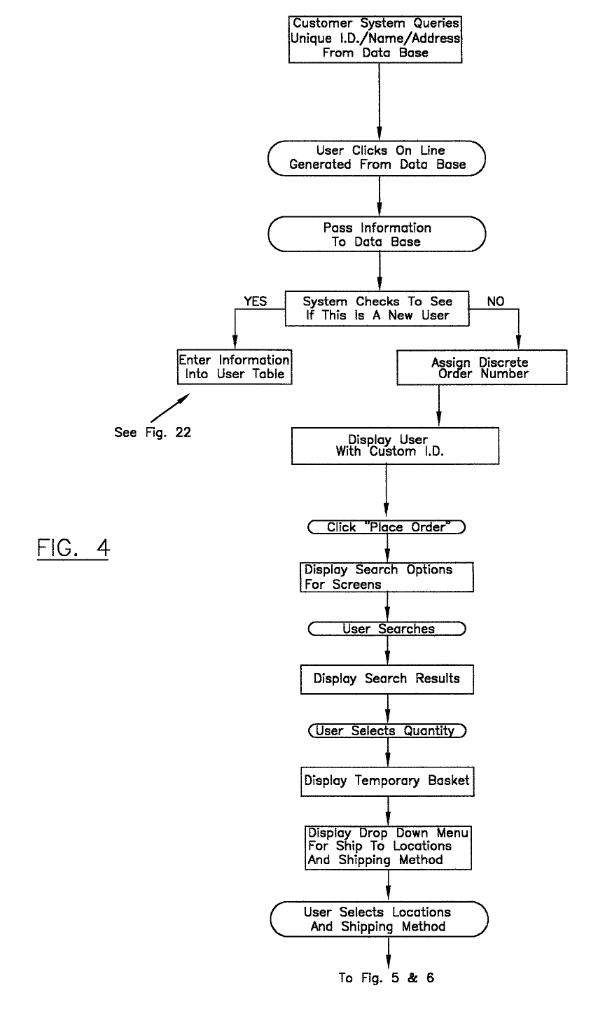

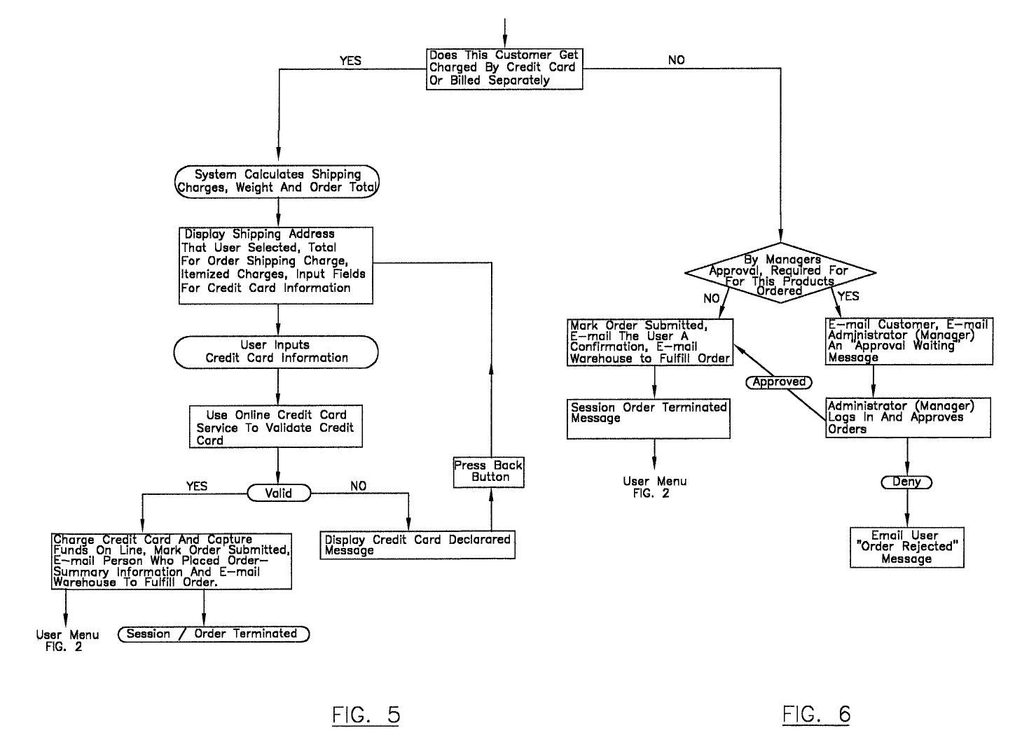

The general overall operation and functionality of the order and inventory management system at the operator or customer order data and control access level is best understood with reference to FIGS. 4 and 5. As shown, the operations or functions at the operator or customer order data and control access level include: log in, place orders, view basket, view order status, ship to administrator, change password, and log out. The additional operations and functions associated with the order and inventory management system administrator management data and control access level are best understood with reference to FIGS. 6 through 15.

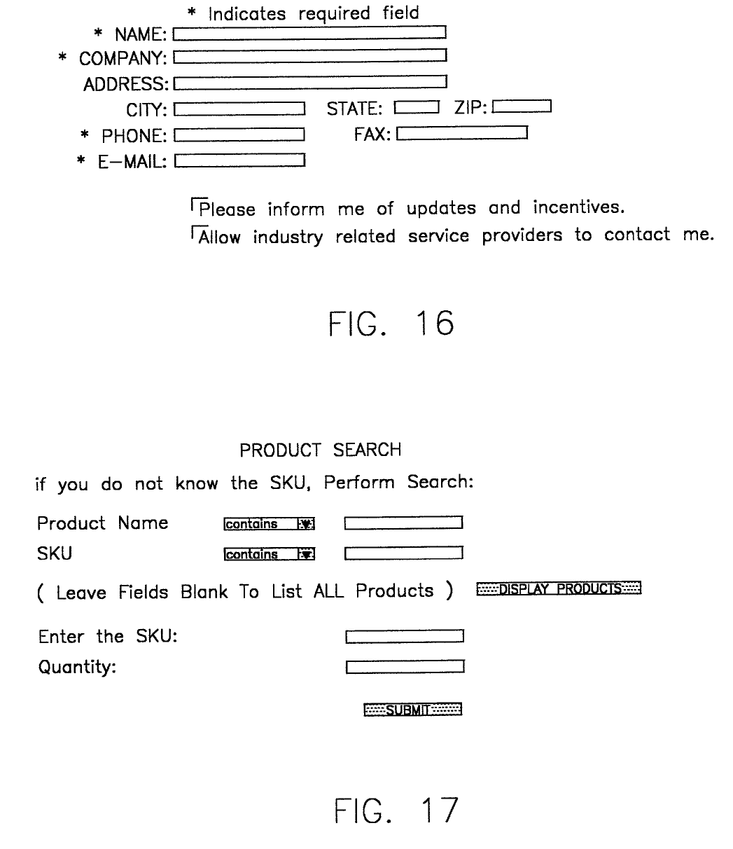

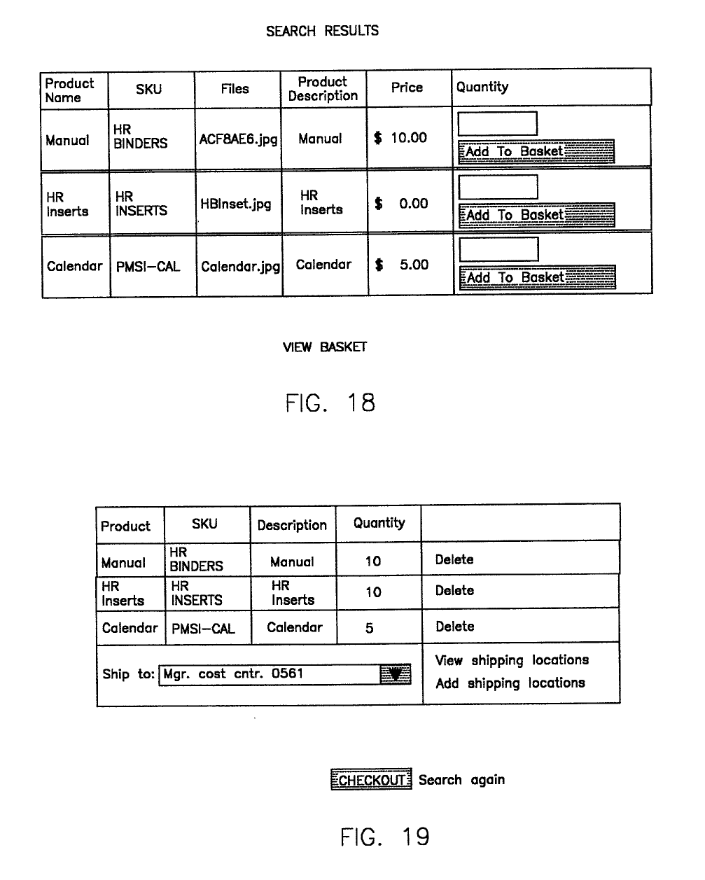

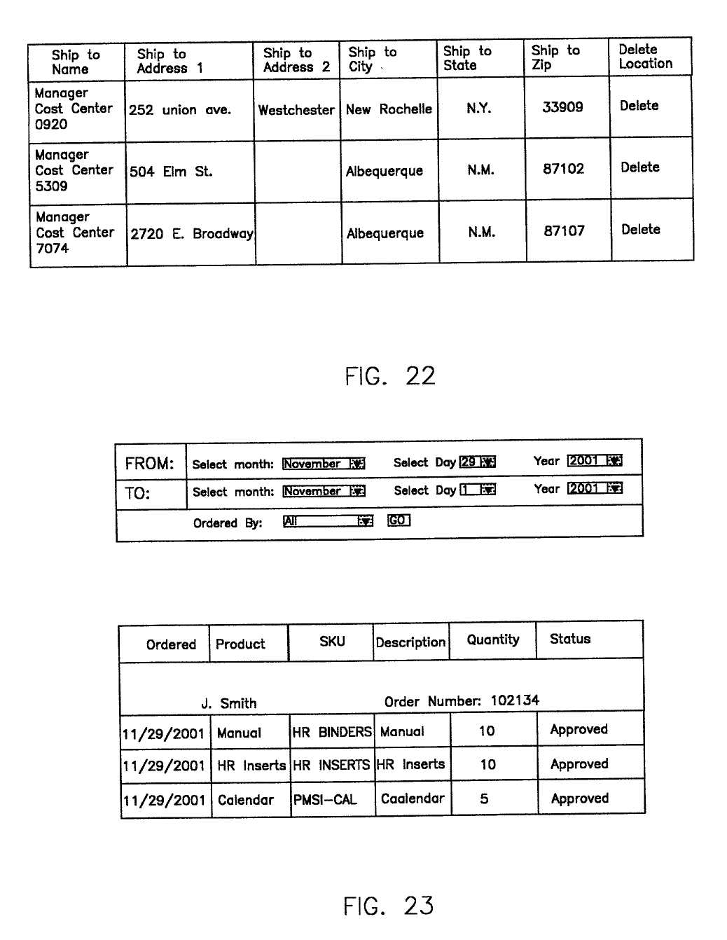

As shown in FIG. 4, when operating in the user or operator access level of the order and inventory management system, the operator at the customer computer 14 at the customer site 16 clicks on-line and accesses the data base 34, the system checks to determines whether or not the query is from an existing or new customer. If a new user, the system prompts the user or operator to enter information into the user table (FIG. 16). Whether a new or established customer, a discrete order number is assigned to each new order. The user then clicks to ‘place’ an order. The user selects an option from a display of search options, searches for the information desired (FIG. 17), reviews search results (FIG. 18), selects quantity (FIG. 19), clicks amount into temporary basket, clicks to drop down menu for ship to locations and methods, selects ship to locations from preexisting list (FIG. 22), creating a ship to account (FIG. 21) and selects a shipping method, indicates whether customer billing is by credit or invoice (billed separately or otherwise).

If the order is on credit or invoice, FIG. 5 shows the flow chart whereby the system calculates shipping charges, weight and order total, displays selected shipping address, total shipping charges, itemized charges, input fields for credit information. The user enters credit information or invoice billing information for validation. If validated, the system will charge a credit and capture funds on line or generate an invoice, mark order “Submitted”, confirm on line the order with the person who placed the order a summary of order information through customer computer 14, and notify on line the warehouse/distribution center or facility 24 to fulfill the order. If the order is not validated or approved, the screen 36 displays a credit declared unaccepted message and the operator may click back to input field for credit information, or click forward to the administrator's menu (FIG. 3).

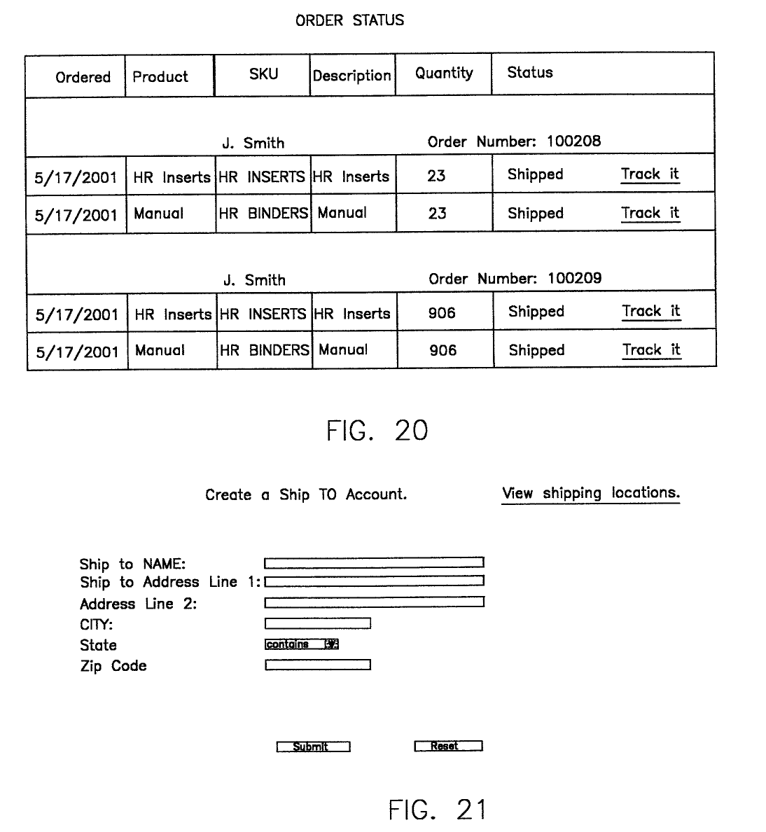

Order Status (FIG. 20)—Discuss

As shown in FIG. 6, if manager approval is required for the products ordered, the system generates a customer on line or e-mail and an administrator on line or e-mail “approval waiting” message. If the manager logs in and approves the order, the order is submitted, an on line or e-mail of order confirmation is transmitted to the customer and an on line e-mail is transmitted to the warehouse/distribution center or facility 22 to fill the order. If the order is not approved, the system generates an ‘order rejected’ on line message transmitted to the customer.

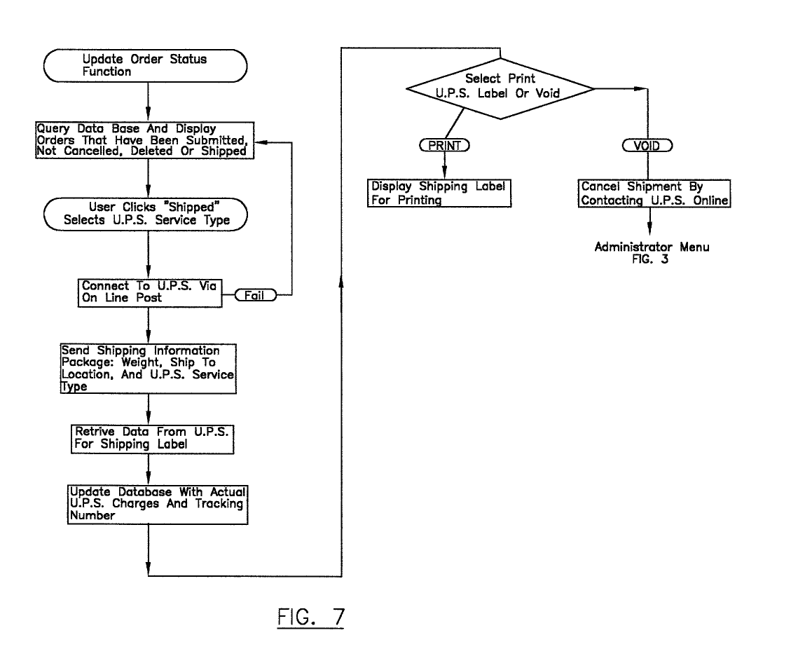

The administrator access level includes a number of additional functions shown in FIGS. 7 through 15. Specifically, update order status function (FIG. 7) wherein the administrator can query the data base 34 and display orders that have been submitted, not cancelled, deleted or shipped on the screen 36; click ‘shipped’ to select the mode or means of transport 24 such as U.P.S. Service Type transportation/shipper facility 26; connect to U.P.S transportation/shipper facility 26 on-line; send shipping information package such as weight, ship to location and U.P.S. Service Type; retrieve data from U.P.S. for shipping label; update database with actual U.P.S. charges and tracking number, select print to printout U.P.S. label and print label; or void and cancel shipment by contacting U.P.S., all over the data communications link 18.

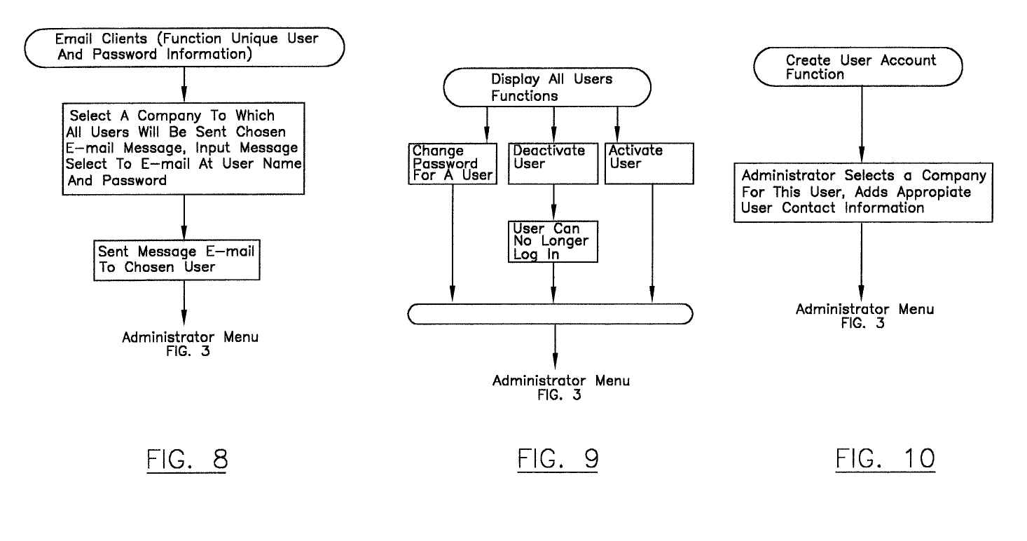

Unique user and password information (FIG. 8), displays all user information such as selection of company to which all users will be sent chosen e-mail messages, input message selected to e-mail at user name and password, and send on line message or e-mail to chose user.

FIG. 9 displays all user accounts and allows user to change password, deactivate user, or activate user; user can no longer log in.

FIG. 10 creates user account allowing administrator to select a company for user and add appropriate user contact information.

The supplier has significantly greater access to and control over the order and inventory management system.

The function depicted in FIG. 11 allows administrator to add product and select customer types, product name, description, SKU and price manager into database.

The inventory function depicted in FIG. 12 queries the database and displays for all customers—sorted by Customer and SKU; audit at product; add or delete associated prices with selected product; display detail information on these products; and update product information or adjust information.

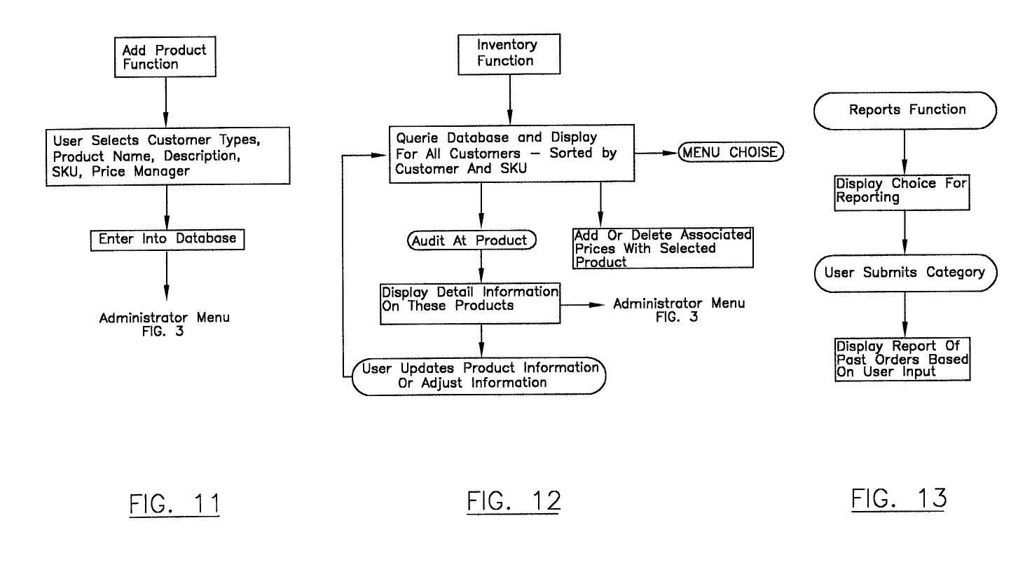

The reports function shown in FIG. 13 displays choice for reporting, user submits category and displays report of past orders based on user input.

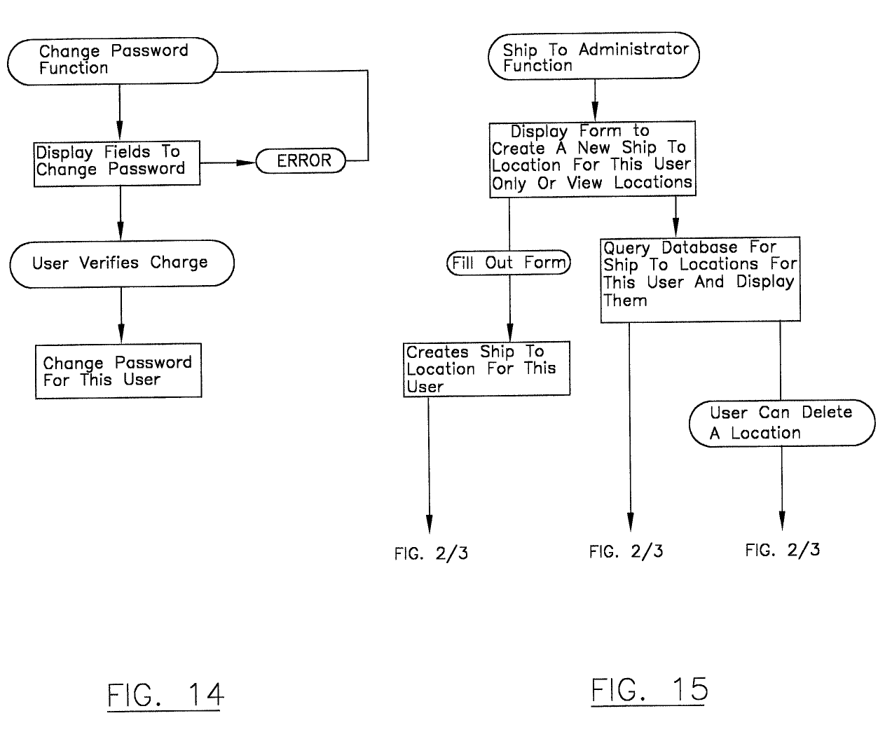

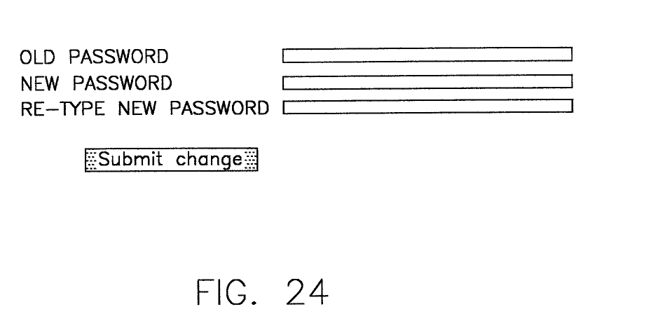

FIG. 14 shows how the administrator can change password, verifies the changes and changes the password. FIG. 24 depicts the screen for accomplishing this function.

FIG. 15 shows an administrator option selection to ‘ship to administrator’ including display form to create a new ship to location for this user only or view locations, fill out form and create ship to location for this user, or query database for ship to locations for this user and display them such that user can delete a location.

Initially, either an existing customer or a prospective customer establishes communications with the supplier computer 10 through the customer computer 14 over the data communications link 18.

In use, the operator signs on with the customer computer 14 by entering the information shown in FIG. 16. The operator selects one of the functions from the user menu as shown in FIG. 2. The operator can order products directly using appropriate product SKUs. If the operator does not know the appropriate SKUs, a product search may be selected as shown in FIG. 17 to determine and enter the SKUs and to designate the desired quantity for the desired product(s). Alternatively, visual images of the actual products may be selected for display and ordering.

Search results may be displayed for display and order selection as shown in FIG. 18. Selected products can then be designated for selected predesignated locations or other locations and entered as shown in FIG. 19 by selecting one or more predesignated locations (FIG. 22) or entering shipping information (FIG. 21).

Various reports can be generated, displayed and reviewed by a particular customer administrator for that customer's records or the supplier can generate, display and review reports globally or by customer, as shown in FIG. 23. The reports can be organized by time period, product, specific date, specific customer, specific order location, specific item number or SKU with or without prices, receiving locations and other pertinent or relevant category.

Predetermined inventory levels for individual products can be set and automatically flagged by the warehouse/distribution center or facility computer 20 to automatically replenish the inventory level for that particular product to a predetermined stocking level.

The system can compare the quantity a particular product with inventory and when the inventory of an ordered product is insufficient to completely fill an order, the request for that particular product is held until the entire order for that product can be fulfilled.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. An order and inventory management system to fulfill customer requisitions and provide current product inventory status information comprising a supplier computer having information processing and storage capabilities to establish inventory of products and designated shipping sites , to establish and maintain product inventory counts, receive, accept, fulfill, ship and bill individual customer product requests, to track status of customer product requests and to generate customer product order reports and at least one customer computer having information processing and storage capabilities to order products for shipment to designated sites and to selectively request customer product order reports operatively coupled by a data communications link capable of transferring data and information

2. The order and inventory management system of claim 1 further including a transportation/shipper facility computer coupled to said supplier computer and said data communications link to transfer shipping information therebetween.

3. The order and inventory management system of claim 2 wherein said designated sites are predetermined.

4. The order and inventory management system of claim 3 wherein said designated sites are selectively entered with specific product orders.

5. The order and inventory management system of claim 2 wherein said designated sites are selectively entered with a specific product order.

6. The order and inventory management system of claim 2 further including a warehouse/distribution center or facility computer coupled to, said supplier computer and said transportation/shipper facility computer by said data communication link whereby real time inventory level reporting and shipping information such as tracking numbers are sent to an ordering customer upon completion of shipment from said warehouse distribution center or facility.

7. The order and inventory management system of claim 1 further includes a warehouse/distribution center or facility computer coupled to a warehouse/distribution center or facility, said supplier computer, said transportation/shipper facility computer by said data communication link whereby real time inventory level reporting and shipping information such as tracking numbers are sent to customer upon completion of shipment from said warehouse distribution center or facility.

8. The order and inventory management system of claim 7 said tracking information is directly linked between said customer computer and said transportation/shipping facility computer for ease of tracking and data retrieval.

9. The order and inventory management system of claim 7 wherein various reports are generated, displayed and reviewed by a particular customer administrator for that customer's records or the supplier can generate, display and review reports globally or by customer; said reports can be organized by time period, product, specific date, specific customer, specific order location, specific item number or SKU with or without prices, receiving locations and other pertinent or relevant category.

10. The order and inventory management system of claim 6 wherein predetermined inventory levels for individual products are set and automatically flagged by said warehouse/distribution center or facility computer to automatically replenish the inventory level for that particular product to a predetermined stocking level.

11. The order and inventory management system of claim 1 further including a warehouse/distribution center or facility computer coupled to, said supplier computer and customer computer by said data communication link whereby real time inventory level reporting and shipping information such as tracking numbers are sent to an ordering customer upon completion of shipment from said warehouse distribution center or facility.

12. The order and inventory management system of claim 11 further including a transportation/shipper facility computer coupled to said supplier computer and said data communications link to transfer shipping information therebetween.

13. The order and inventory management system of claim 12 said tracking information is directly linked between said customer computer and said transportation/shipping facility computer for ease of tracking and data retrieval.

14. The order and inventory management system of claim 12 wherein various reports are generated, displayed and reviewed by a particular customer administrator for that customer's records or the supplier can generate, display and review reports globally or by customer; said reports can be organized by time period, product, specific date, specific customer, specific order location, specific item number or SKU with or without prices, receiving locations and other pertinent or relevant category.

15. The order and inventory management system of claim 11 wherein predetermined inventory levels for individual products are set and automatically flagged by said warehouse/distribution center or facility computer to automatically replenish the inventory level for that particular product to a predetermined stocking level.

16. The order and inventory management system of claim 11 wherein said designated sites are predetermined.

17. The order and inventory management system of claim 11 wherein said designated sites are selectively entered with specific product orders.

18. The order and inventory management system of claim 4 wherein said designated sites are selectively entered with a specific product order.
